(19) United States
(12) Patent Application Publication
(10) Pub. No.: US 2024/0217797 A1
(43) Pub. Date: Jul. 4, 2024

(54) METAL 3D PRINTED INTEGRATED PUMP-CONTROLLED HYDRAULIC LEVELING SYSTEM AND FIRE FIGHTING VEHICLE

(71) Applicant: JIANGSU XCMG CONSTRUCTION MACHINERY RESEARCH INSTITUTE LTD., Xuzhou (CN)

(72) Inventors: Bing HE, Xuzhou (CN); Fuxiang BO, Xuzhou (CN); Lei XU, Xuzhou (CN); Yi ZHU, Xuzhou (CN)

(21) Appl. No.: 18/141,001

(22) Filed: Apr. 28, 2023

(30) Foreign Application Priority Data
Dec. 30, 2022 (CN) 202211727010.6

(51) Int. Cl. B66F 11/04; A62C 27/00

(52) U.S. Cl. CPC B66F 11/044; A62C 27/00; B33Y 80/00

(57) ABSTRACT

An aerial work platform for a fire fighting vehicle includes: a carrying component; a work platform body mounted on the carrying component and swingable relative to the carrying component to adjust the levelness of the work platform body; a hydraulic actuating element connected to the carrying component and the work platform body, respectively, and configured to drive the work platform body to swing relative to the carrying component; and a hydraulic power unit including a hydraulic pump and a first reversing valve fluidly connected to the hydraulic pump, the first reversing valve being fluidly connected to the hydraulic actuating element, the hydraulic power unit including a first component, the first component being formed with a first pump cavity accommodating a pumping component of the hydraulic pump and a first reversing valve cavity accommodating a valve core of the first reversing valve.

### CROSS-REFERENCE TO RELATED APPLICATIONS

The present disclosure is based on and claims priority to CN application No. CN202211727010.6, filed on Dec. 30, 2022, the disclosure of which is hereby incorporated by reference in its entirety.

### FIELD OF THE DISCLOSURE

The present disclosure relates to the technical field of engineering machinery, in particular to an aerial work platform for a fire fighting vehicle and a fire fighting vehicle.

### BACKGROUND OF THE DISCLOSURE

Ladder fire fighting vehicles, aerial fire fighting vehicles, aerial work platforms for fire fighting vehicles, etc. are emergency rescue equipment for the implementation of high-level firefighting, person rescue, and special operations. Manned aerial rescue vehicles represent a field with the highest safety performance requirement, design concept advancement and technology intensiveness among aerial operation vehicles, and has an extremely high technological content. A leveling hydraulic system is a key system for real-time adjustment of the angle of a working platform, and is an important guarantee for maintaining the stability of persons and accurately performing a rescue task by equipment. At present, limited by traditional design and manufacturing process, hydraulic elements of a leveling hydraulic system of an aerial working platform are highly discrete, and low in integration, resulting in a high weight and a great volume of the leveling hydraulic system, such that the effective space of the platform is limited and the safety factor of the aerial platform is reduced, which limits the platform's capacity of carrying diversified rescue equipment and rescue persons. At present, a platform for a fire fighting vehicle with a 53 m ladder in a fire-fighting high-end product series has a carrying capacity of only 300 kg, in which a human carrying space available only accounts for 80%. Pumps, valves, motors, actuators and other elements in its hydraulic system are manufactured separately, connected by pipelines, and dispersedly arranged on the platform, and together with an electrical control system, a fire water cannon and its water pipes, etc. on the platform, result in that the platform has no extra space to arrange new functions. Compared with foreign products, the platform has no space to arrange a relay water supply device, resulting in that firefighters cannot carry an external water source into an indoor space for rescue, which greatly affects the rescue efficiency, but also reduces the competitiveness of the product in the market.

### SUMMARY OF THE DISCLOSURE

The present invention aims to provide an aerial work platform for a fire fighting vehicle and a fire fighting vehicle to improve the problem of unreasonable space utilization of a platform that exists in the prior art.

According to an aspect of embodiments of the present invention, the present invention provides an aerial work platform for a fire fighting vehicle, the aerial work platform for a fire fighting vehicle including:
a carrying component;
a work platform body mounted on the carrying component and swingable relative to the carrying component to adjust the levelness of the work platform body;
a hydraulic actuating element connected to the carrying component and the work platform body, respectively, and configured to drive the work platform body to swing relative to the carrying component; and
a hydraulic power unit including a hydraulic pump and a first reversing valve fluidly connected to the hydraulic pump, the first reversing valve being fluidly connected to the hydraulic actuating element, the hydraulic power unit including a first component, the first component being formed with a first pump cavity accommodating a pumping component of the hydraulic pump and a first reversing valve cavity accommodating a valve core of the first reversing valve.

In some embodiments, the first component is formed by 3D printing.

In some embodiments, the first component is further formed with a flow passage fluidly connecting the hydraulic pump and the first reversing valve, and hydraulic fluid inlet-outlets for fluidly connecting the hydraulic actuating element and the first reversing valve.

In some embodiments, the hydraulic power unit further includes a first relief valve fluidly connected to the hydraulic pump, and the first component is further provided with a first relief valve cavity accommodating a valve core of the first relief valve.

In some embodiments, the hydraulic power unit further includes a motor in transmission connection with the hydraulic pump, the motor being mounted at an end of the first component.

In some embodiments, the hydraulic power unit further includes a hydraulic fluid tank communicated with the hydraulic pump, the hydraulic fluid tank being mounted at the other end of the first component away from the motor.

In some embodiments, the aerial work platform for a fire fighting vehicle further includes a controller in signal connection with the motor, the controller being configured to control an actuating quantity of the hydraulic actuating element by controlling a rotating speed of the motor.

In some embodiments, the aerial work platform for a fire fighting vehicle further includes a manual control unit, the manual control unit including a human manipulated second reversing valve, the second reversing valve being fluidly connected to the hydraulic actuating element.

In some embodiments, the aerial work platform for a fire fighting vehicle further includes a first shuttle valve, a first inlet of the first shuttle valve being fluidly connected to the first reversing valve, a second inlet of the first shuttle valve being fluidly connected to the second reversing valve, an outlet of the first shuttle valve being fluidly connected to the hydraulic actuating element, the first component being further provided with a first shuttle valve cavity accommodating a valve core of the first shuttle valve.

In some embodiments, the manual control unit further includes a second component, the second component being provided with a second reversing valve cavity accommodating a valve core of the second reversing valve.

In some embodiments, the manual control unit further includes a human powered pump fluidly connected to the second reversing valve.

In some embodiments,
the second component is provided with a second pump cavity accommodating a pumping component of the human powered pump: and
the manual control unit further includes a second relief valve fluidly connected to the human powered pump, and the second component is provided with a second relief valve cavity accommodating a valve core of the second relief valve.

In some embodiments, the second component is formed by 3D printing.

In some embodiments, the hydraulic actuating element includes a swing hydraulic cylinder, the swing hydraulic cylinder including a fixed component and a rotating component that rotates relative to the fixed component under the drive of hydraulic fluid, one of the fixed component and the rotating component being connected to the carrying component, and the other being connected to the work platform body.

According to another aspect of the present invention, a fire fighting vehicle is also provided, the fire fighting vehicle including the above-mentioned aerial work platform for a fire fighting vehicle.

In application of the technical solutions of the present application, the first pump cavity for the hydraulic pump and the first reversing valve cavity are both integrated on the first component, which is conducive to implementing a small size and a light weight of the hydraulic power unit, and also conducive to reducing the number of parts and components of the hydraulic power unit

Other features and advantages of the present disclosure will become apparent from the following detailed description of exemplary embodiments of the present disclosure with reference to the accompanying drawings.

### BRIEF DESCRIPTION OF THE ACCOMPANYING DRAWINGS

The drawings as a part of the present disclosure are used to provide further understanding of the present disclosure. Illustrative embodiments of the present disclosure and description thereof are used for explaining the present disclosure but do not improperly limit the present disclosure. In the drawings:

FIG. 1 shows a stereoscopic structural diagram of an aerial work platform for a fire fighting vehicle in an embodiment of the present invention:

FIG. 2 shows a stereoscopic structural diagram of an aerial work platform for a fire fighting vehicle at another angle in an embodiment of the present invention:

FIG. 3 shows a diagram of a hydraulic system of an aerial work platform for a fire fighting vehicle in an embodiment of the present invention:

FIG. 4 shows a structural diagram of a hydraulic system of an aerial work platform for a fire fighting vehicle in an embodiment of the present invention:

FIG. 5 shows a structural diagram of a hydraulic power unit of an aerial work platform for a fire fighting vehicle in an embodiment of the present invention:

FIG. 6 shows a structural diagram of a manual control unit of an aerial work platform for a fire fighting vehicle in an embodiment of the present invention:

FIG. 7 shows a structural diagram of second component of an aerial work platform for a fire fighting vehicle in an embodiment of the present invention:

FIG. 8 shows a stereoscopic structural diagram of a hydraulic actuating element of an aerial work platform for a fire fighting vehicle in an embodiment of the present invention:

FIG. 9 shows a stereoscopic structural diagram of a hydraulic actuating element of an aerial work platform for a fire fighting vehicle at another angle in an embodiment of the present invention: and

FIG. 10 shows a structural diagram of a fire fighting vehicle in an embodiment of the present invention.

### REFERENCE NUMERALS

1, work platform body; 2, hydraulic power unit; 3, manual control unit; 4; 5, carrying component; 6, hydraulic fluid tank; 7, hydraulic pump; 8, motor; 9, first reversing valve; 10, first relief valve; 11, first shuttle valve; 12, second shuttle valve; 13, human powered pump; 14, second relief valve; 15, second reversing valve; 16, first component; 17, second component; 18, hydraulic fluid inlet-outlet; 19, fixed component; 20, rotating component; 21, connecting lug; 22, flange; 23, rotation detection component; 24, hollowed-out structure; 25, work arm; 26, balance valve.

### DETAILED DESCRIPTION OF THE PREFERRED EMBODIMENTS

The technical solutions in the embodiments of the present invention will be described below clearly and completely in conjunction with the accompanying drawings in the embodiments of the present invention. Obviously, the described embodiments are only a part of the embodiments of the present invention, and not all the embodiments. The following description of at least one exemplary embodiment is actually only illustrative, and in no way serves as any limitation on the present invention and its application or use. All other embodiments obtained by those of ordinary skill in the art without creative work, based on the embodiments in the present invention, fall into the protection scope of the present invention.

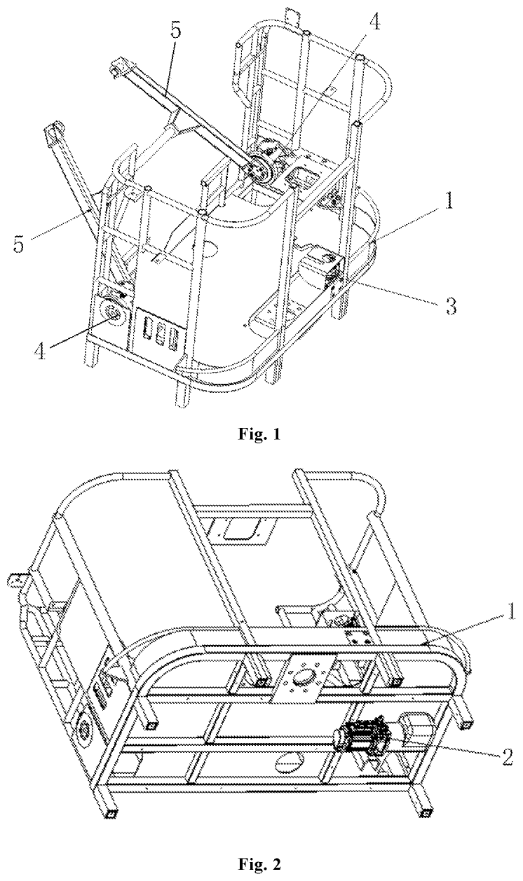

In conjunction with FIGS. 1 to 4, an aerial work platform for a fire fighting vehicle of this embodiment includes a carrying component 5, an work platform body 1, a hydraulic actuating element 4 and a hydraulic power unit 2.

The work platform body 1 is mounted on the carrying component 5 and swingable relative to the carrying component 5 to adjust the levelness of the work platform body 1. The hydraulic actuating element 4 is connected to the carrying component 5 and the work platform body 1, respectively, and configured to drive the work platform body 1 to swing relative to the carrying component 5. The hydraulic power unit 2 includes a hydraulic pump 7 and a first reversing valve 9 fluidly connected to the hydraulic pump 7. The first reversing valve 9 is fluidly connected to the hydraulic actuating element 4. The hydraulic power unit 2 includes a first component 16. The first component 16 is formed with a first pump cavity accommodating a pumping component of the hydraulic pump 7 and a first reversing valve cavity accommodating a valve core of the first reversing valve 9.

In this embodiment, the first pump cavity for the hydraulic pump 7 and the first reversing valve cavity are both integrated on the first component, which is conducive to implementing a small size and a light weight of the hydraulic power unit 2, and also conducive to reducing the number of parts and components of the hydraulic power unit 2.

In some embodiments, the hydraulic pump 7 is a gear pump, and the pumping component is a gear of the gear pump. In some other embodiments, the hydraulic pump 7 is an impeller pump, and the pumping component is an impeller of the impeller pump. In some other embodiments, the hydraulic pump 7 is a plunger pump, and the pumping component is a plunger of the plunger pump.

In some embodiments, the first component 16 is formed by 3D printing.

The first component 16 is further formed with a flow passage fluidly connecting the hydraulic pump 7 and the first reversing valve 9, and hydraulic fluid inlet-outlets 18 for fluidly connecting the hydraulic actuating element 4 and the first reversing valve 9.

In this embodiment, the first reversing valve 9 includes an inlet communicated with the hydraulic pump 7, a return port communicated with a hydraulic fluid tank 6, a first working port connected to a first cavity of the hydraulic actuating element 4, and a second working port connected to a second cavity of the first hydraulic actuating element 4. In some embodiments, the first cavity is a rod cavity of the hydraulic actuating element 4, and the second cavity is a rodless cavity of the hydraulic actuating element 4.

When hydraulic fluid is introduced into the first cavity of the hydraulic actuating element 4 and the hydraulic fluid is discharged from the second cavity, a moving component of the hydraulic actuating element 4 moves in a first direction, and when hydraulic fluid is introduced into the second cavity of the hydraulic actuating element 4 and the hydraulic fluid is discharged from the first cavity, the moving component of the hydraulic actuating element 4 moves in a second direction. The second direction is opposite to the first direction.

The first component 16 is provided with two hydraulic fluid inlet-outlets 18. One hydraulic fluid inlet-outlet is communicated with the first working port of the first reversing valve 9, and the other is communicated with the second working port of the first reversing valve 9.

In some embodiments, the hydraulic power unit 2 further includes a first relief valve 10 fluidly connected to the hydraulic pump 7, and the first component 16 is further provided with a first relief valve cavity accommodating a valve core of the first relief valve 10.

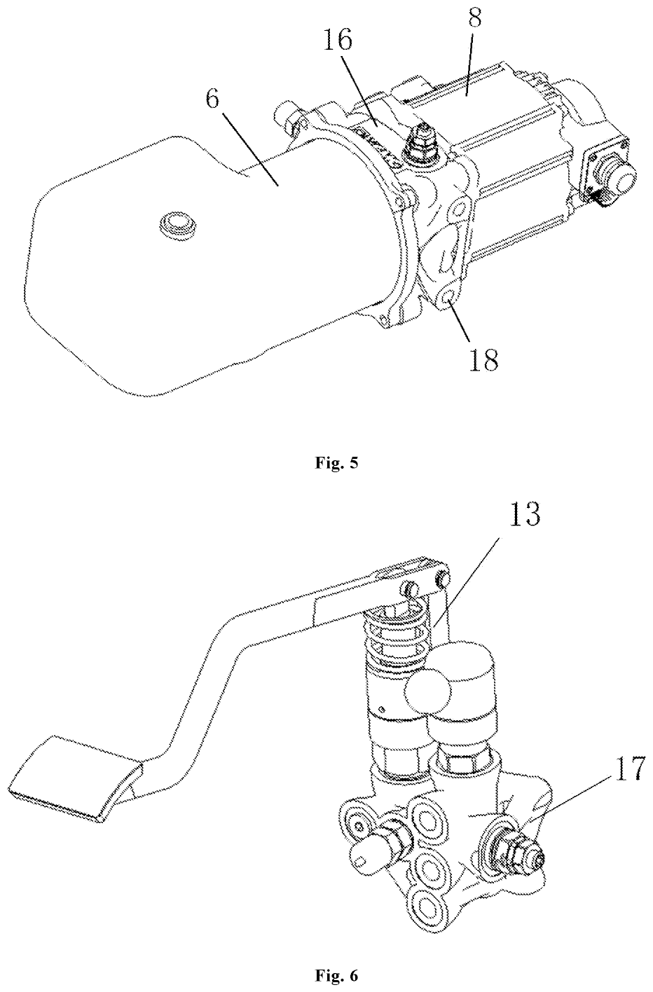

As shown in FIG. 5, the hydraulic power unit 2 further includes a motor 8 in transmission connection with the hydraulic pump 7. The motor 8 is mounted at an end of the first component 16.

In some embodiments, the hydraulic power unit 2 further includes a hydraulic fluid tank 6 communicated with the hydraulic pump 7. The hydraulic fluid tank 6 is mounted at the other end of the first component 16 away from the motor 8.

The aerial work platform for a fire fighting vehicle further includes a controller in signal connection with the motor 8. The controller is configured to control an actuating quantity of the hydraulic actuating element 4 by controlling a rotating speed of the motor 8. In this embodiment, parts and components such as the hydraulic fluid tank 6, the first reversing valve 9, the motor 8 and the hydraulic pump 7 are integrated into an integral whole, which is conducive to implementing a light weight and a small size of the hydraulic power unit 2 and reducing the number of parts and components, thus simplifying the structure of the hydraulic power unit 2 and reducing the space occupied by the hydraulic power unit 2.

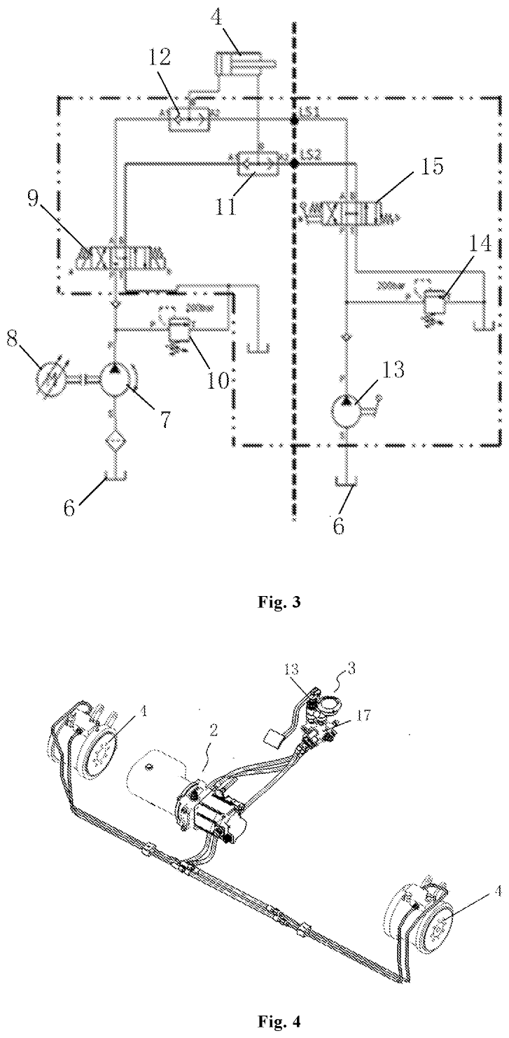

As shown in FIGS. 3, 4 and 6, the aerial work platform for a fire fighting vehicle further includes a manual control unit 3. The manual control unit 3 includes a human manipulated second reversing valve 15. The second reversing valve 15 is fluidly connected to the hydraulic actuating element 4.

The aerial work platform for a fire fighting vehicle further includes a first shuttle valve 11. A first inlet of the first shuttle valve 11 is fluidly connected to the first reversing valve 9, a second inlet of the first shuttle valve 11 is fluidly connected to the second reversing valve 15, and an outlet of the first shuttle valve 11 is fluidly connected to the hydraulic actuating element 4. The first component 16 is further provided with a first shuttle valve cavity accommodating a valve core of the first shuttle valve 11.

In some embodiments, the first component 16 is made of one of carbon steel, alloy steel, stainless steel, and aluminum alloy. The first component 16 adopts topology optimization design.

The second reversing valve 15 includes an inlet for introducing hydraulic fluid, a return port communicated with a hydraulic fluid tank 6, a first working port connected to a first cavity of the hydraulic actuating element 4, and a second working port connected to a second cavity of the first hydraulic actuating element 4. In some embodiments, the first cavity is a rod cavity of the hydraulic actuating element 4, and the second cavity is a rodless cavity of the hydraulic actuating element 4.

In this embodiment, the outlet of the first shuttle valve 11 is connected to the rod cavity of the hydraulic actuating element 4, the first inlet of the first shuttle valve 11 is fluidly connected to the first working port of the first reversing valve 9, and the second inlet of the first shuttle valve 11 is fluidly connected to the first working port of the second reversing valve 15.

The aerial work platform for a fire fighting vehicle further includes a second shuttle valve 12. An outlet of the second shuttle valve 12 is connected to the rodless cavity of the hydraulic actuating element 4, a first inlet of the second shuttle valve 12 is fluidly connected to the second working port of the first reversing valve 9, and a second inlet of the second shuttle valve 12 is fluidly connected to the second working port of the second reversing valve 15.

In some embodiments, the manual control unit 3 further includes a second component 17. The second component 17 is provided with a second reversing valve cavity accommodating a valve core of the second reversing valve 15.

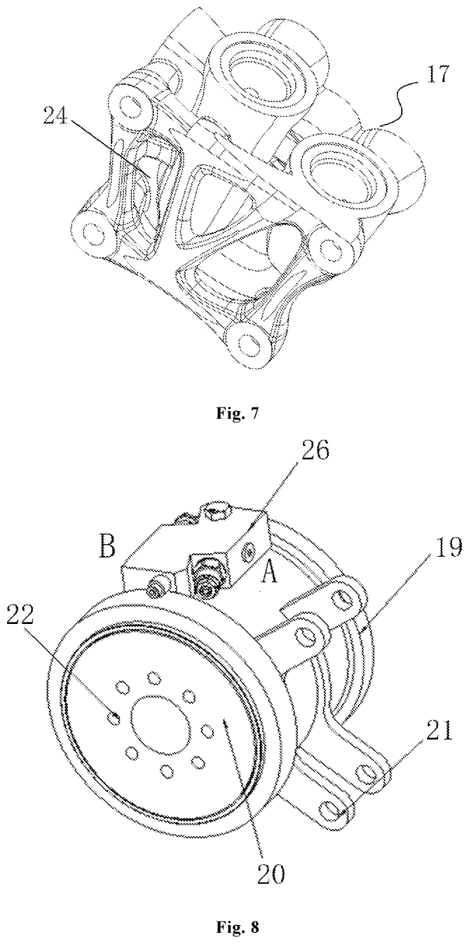

The second component 17 is made of one of carbon steel, alloy steel, stainless steel and aluminum alloy. The second component 17 adopts topology optimization design, and is provided with a hollowed-out structure 24 where there is no hydraulic flow passage to reduce the mass of the second component 17, as seen in FIG. 7.

As shown in FIG. 6, the manual control unit 3 further includes a human powered pump 13 fluidly connected to the second reversing valve 15.

The second component 17 is provided with a second pump cavity accommodating a pumping component of the human powered pump 13: and the manual control unit 3 further includes a second relief valve 14 fluidly connected to the human powered pump 13, and the second component 17 is provided with a second relief valve cavity accommodating a valve core of the second relief valve 14.

In this embodiment, the second reversing valve 15 and the human powered pump 13 of the manual control unit 3 are integrated into an integral component, which is conducive to implementing a light weight and a small size of the manual control unit 3 and reducing the number of parts and components, thus simplifying the structure of the manual control unit 3 and reducing the space occupied by the manual control unit 3.

In some embodiments, the second component 17 is formed by 3D printing.

In this embodiment, the human powered pump 13 is a foot-operated human powered pump. The manual control unit 3 is mounted above a base of the work platform body 1 and located at the bottom of a fence of the work platform body 1. The hydraulic power unit 2 is located below the base of the work platform body 1 to save a working space on the work platform body 1.

As shown in FIGS. 8 and 9, the hydraulic actuating element 4 includes a swing hydraulic cylinder. The swing hydraulic cylinder includes a fixed component 19 and a rotating component 20 that rotates relative to the fixed component 19 under the drive of hydraulic fluid. One of the fixed component 19 and the rotating component 20 is connected to the work platform body 1, and the other is connected to the carrying component 5.

The aerial work platform for a fire fighting vehicle further includes a balance valve 26. The balance valve 26 is fluidly connected to the hydraulic actuating element 4 to ensure the smoothness of movement of the hydraulic actuating element 4.

The balance valve 26 includes a first fluid port A and a second fluid port B. Hydraulic fluid is introduced into one of the first fluid port A and the second fluid port B, and the hydraulic fluid is discharged from the other to the hydraulic fluid tank 6. When the hydraulic fluid is introduced into the first fluid port A, the rotating component 20 rotates counter-clockwise, and when the hydraulic fluid is introduced into the second fluid port B, the rotating component 20 rotates clockwise.

The fixed component 19 is provided with connecting lugs 21 for connecting the work platform body 1. The rotating component 20 is provided with flanges 22 for connecting the carrying component 5.

The aerial work platform for a fire fighting vehicle further includes a rotation detection component 23 for detecting a rotation amount of the rotating component 20. In some embodiments, the rotation detection component 23 includes an encoder.

The aerial work platform for a fire fighting vehicle further includes an angle detection component for detecting an angle of the work platform body 1 relative to a horizontal direction. An attitude of the work platform body 1 is monitored in real time by monitoring the angle detected by the angle detection component and the rotation amount detected by the rotation amount detection component.

As shown in FIGS. 1 and 2, the carrying component 5 includes a connecting arm, and the hydraulic actuating element 4 is mounted on the base of the work platform body 1, and the connecting arm is connected to the hydraulic actuating element 4 and extends in a direction away from the work platform body 1. In some embodiments, the work platform body 1 is provided with two hydraulic actuating elements 4, and each hydraulic actuating elements 4 is connected to a connecting arm. The two hydraulic actuating elements 4 are arranged symmetrically with respect to a centerline of the work platform body 1.

In some embodiments, the hydraulic actuating element 4 is a lightweight, small-sized, high-torque swing hydraulic cylinder. Compared with linear-motion hydraulic cylinders or other linear-motion devices of the prior art, it has the characteristics of small space occupation and a light weight.

The diameter of the swing hydraulic cylinder is smaller than or equal to 198 mm, the axial length of the swing hydraulic cylinder is smaller than or equal to 171 mm, a rotation angle of the rotating component 20 is greater than or equal to 170°, and a single hydraulic cylinder can output a torque of 2300 NM under a hydraulic fluid pressure of 20 MPa.

The hydraulic power unit 2 of this embodiment can be assembled on ladder fire fighting vehicles, aerial fire fighting vehicles, aerial platforms, scissor-type aerial platforms and other aerial emergency rescue fire fighting vehicles.

The aerial work platform for a fire fighting vehicle of this embodiment has the following technical effects:
(1) Low energy consumption of the system: the hydraulic power unit 2 of this embodiment uses metal 3D printing technology to achieve conforming design of an oil passage structure, and conforming integrated design of plug-ins, such that a flow passage pressure loss is reduced: the hydraulic actuating element 4 is controlled in a pump-controlled manner, which, compared with a traditional method of controlling in a valve-controlled manner, directly achieves flow supply as needed by using the high-precision motor 8, thereby reducing waste, such that the system is maintained in efficient operating work all the time, and the motor does not need to rotate at a high speed, and is automatically adjusted according to the speed requirement, thus greatly reducing energy consumption of the system.
(2) Large space of the work platform: the hydraulic power unit 2 of this embodiment implements integrated design of multiple elements, and applies metal 3D printing topology optimization design technology to achieve overall compact arrangement of the hydraulic system, such that different from traditional discrete arrangement of hydraulic elements, the platform space is greatly released, which is conducive to arrangement of other brand new functions for the whole machine, thus effectively improving the functionality of the whole machine.
(3) Low weight of the system: the weight of the hydraulic power unit 2 of this embodiment is only 40% of that in a traditional solution, which can effectively achieve a carrying capacity increase of 50 Kg, and help the whole machine to carry more rescue equipment, or rescue more persons, thus effectively improving the competitiveness of the product.
(4) Low cost: the hydraulic power unit 2 of this embodiment uses the motor for driving, which avoids the purchase of an expensive proportional valve, thus effectively reducing the overall cost of the system.
(5) Strong power of the platform: the hydraulic power unit 2 of this embodiment is equipped with a spiral swing hydraulic cylinder with a small volume, which not only reduces the weight and volume, but also provides a greater torque under the same pressure, such that the rotational leveling power of the platform is more adequate to effectively support the increase of the carrying capacity and rescue ability of the platform.

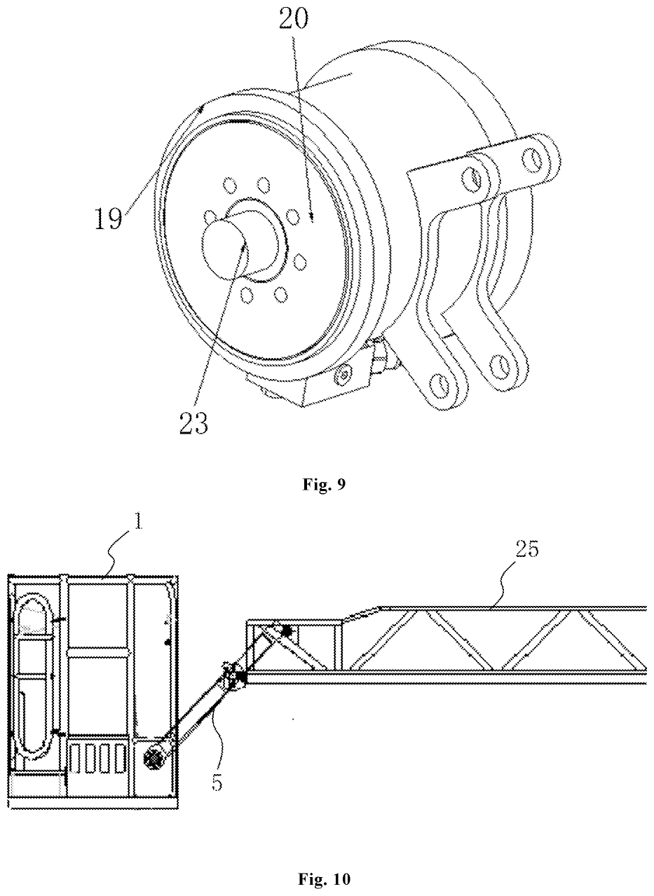

According to another aspect of the present invention, a fire fighting vehicle is also provided. The fire fighting vehicle includes the above-mentioned aerial work platform for a fire fighting vehicle. As shown in FIG. 10, the fire fighting vehicle includes a work arm 25, and an work platform body 1 is mounted to the work arm 25 by means of a carrying component 5.

Described above are only exemplary embodiments of the present invention, which are not intended to limit the present invention, and all modifications, equivalent substitutions and improvements made within the spirit and principle of the present invention should be encompassed within the protection scope of the present invention.

What is claimed is:

1. An aerial work platform for a fire fighting vehicle, comprising:
a carrying component;
a work platform body mounted on the carrying component and swingable relative to the carrying component to adjust the levelness of the work platform body;
a hydraulic actuating element connected to the carrying component and the work platform body, and configured to drive the work platform body to swing relative to the carrying component; and
a hydraulic power unit comprising a hydraulic pump and a first reversing valve fluidly connected to the hydraulic pump, the first reversing valve being fluidly connected to the hydraulic actuating element, the hydraulic power unit comprising a first component, the first component being formed with a first pump cavity accommodating a pumping component of the hydraulic pump and a first reversing valve cavity accommodating a valve core of the first reversing valve.

2. The aerial work platform for a fire fighting vehicle according to claim 1, wherein the first component is formed by 3D printing.

3. The aerial work platform for a fire fighting vehicle according to claim 1, wherein the first component is further formed with a flow passage fluidly connecting the hydraulic pump and the first reversing valve, and hydraulic fluid inlet-outlets fluidly connecting the hydraulic actuating element and the first reversing valve.

4. The aerial work platform for a fire fighting vehicle according to claim 1, wherein the hydraulic power unit further comprises a first relief valve fluidly connected to the hydraulic pump, and the first component is further provided with a first relief valve cavity accommodating a valve core of the first relief valve.

5. The aerial work platform for a fire fighting vehicle according to claim 1, wherein the hydraulic power unit further comprises a motor in transmission connection with the hydraulic pump, the motor being mounted at an end of the first component.

6. The aerial work platform for a fire fighting vehicle according to claim 5, wherein the hydraulic power unit further comprises a hydraulic fluid tank fluidly communicated with the hydraulic pump, the hydraulic fluid tank being mounted at an end of the first component away from the motor.

7. The aerial work platform for a fire fighting vehicle according to claim 5, further comprising a controller in signal connection with the motor, the controller being configured to control an actuating quantity of the hydraulic actuating element by controlling a rotating speed of the motor.

8. The aerial work platform for a fire fighting vehicle according to claim 1, further comprising a manual control unit, the manual control unit comprising a human manipulated second reversing valve, the second reversing valve being fluidly connected to the hydraulic actuating element.

9. The aerial work platform for a fire fighting vehicle according to claim 8, further comprising a first shuttle valve, a first inlet of the first shuttle valve being fluidly connected to the first reversing valve, a second inlet of the first shuttle valve being fluidly connected to the second reversing valve, an outlet of the first shuttle valve being fluidly connected to the hydraulic actuating element, the first component being further provided with a first shuttle valve cavity accommodating a valve core of the first shuttle valve.

10. The aerial work platform for a fire fighting vehicle according to claim 8, wherein the manual control unit further comprises a second component, the second component being provided with a second reversing valve cavity accommodating a valve core of the second reversing valve.

11. The aerial work platform for a fire fighting vehicle according to claim 10, wherein the manual control unit further comprises a human powered pump fluidly connected to the second reversing valve.

12. The aerial work platform for a fire fighting vehicle according to claim 11, wherein
the second component is provided with a second pump cavity accommodating a pumping component of the human powered pump; and
the manual control unit further comprises a second relief valve fluidly connected to the human powered pump, and the second component is provided with a second relief valve cavity accommodating a valve core of the second relief valve.

13. The aerial work platform for a fire fighting vehicle according to claim 10, wherein the second component is formed by 3D printing.

14. The aerial work platform for a fire fighting vehicle according to claim 1, wherein the hydraulic actuating element comprises a swing hydraulic cylinder, the swing hydraulic cylinder comprising a fixed component and a rotating component that rotates relative to the fixed component under the drive of hydraulic fluid, one of the fixed component and the rotating component being connected to the carrying component, and the other being connected to the work platform body.

15. A fire fighting vehicle, comprising the aerial work platform for a fire fighting vehicle of claim 1.
